(19) United States
(12) Patent Application Publication
(10) Pub. No.: US 2005/0243472 A1
(43) Pub. Date: Nov. 3, 2005

(54) Head stack assembly and manufacturing thereof

(75) Inventors: Takehiro Kamigama, Hong Kong (CN); Yiu Sing Ho, Hong Kong (CN); Canhua Chen, Donnguan City (CN)

Correspondence Address: CROWELL & MORING LLP;INTELLECTUAL PROPERTY GROUP, P.O. BOX 14300, WASHINGTON, DC, 20044-4300, US

(73) Assignee: SAE Magnetics (H.K.) Ltd., Hong Kong (CN)

(21) Appl. No.: 10/833,090

(22) Filed: Apr. 28, 2004

(51) Int. Cl. G11B 5/48

(52) U.S. Cl. 360/265.7

(57) ABSTRACT

A method for manufacturing a head stack assembly (HSA) of a disk drive unit includes including the steps of: forming a head arm assembly (HAA) having an overmolded suspension flexure cable thereon and a flexible printed circuit assembly; and bonding the suspension flexure cable with the flexible printed circuit assembly by conductive epoxy to attain an electrical connection therebetween. In the invention, the conductive epoxy is preferably anisotropic conductive film. Forming the head arm assembly further comprises forming a drive arm, and overmolding a suspension, a bracket, and a voice coil thereonto. Also, the method may further include a step of forming another HAA as a part of the HSA. In addition, a structure of the HSA is also disclosed in the present invention.

### FIELD OF THE INVENTION

The present invention relates to disk drive units and manufacturing method thereof, and more particularly to a manufacturing method of a HSA (head stack assembly).

### BACKGROUND OF THE INVENTION

Disk drives are information storage devices that use magnetic media to store data. Referring to FIG. 1, a typical disk drive in prior art comprises a drive arm 5, a head gimbal assembly (HGA) 4 with a slider 3 being coupled to the drive arm 5 (the drive arm and the HGA with the slider also known as head stack assembly (HSA)), a magnetic disk 1 mounted on a spindle motor 2 which causes the magnetic disk 1 to spin, and a disk drive base plate 13 to enclose the above-mentioned components. The slider 3 flies over the surface of the magnetic disk 1 at a high velocity and is positioned radially by a voice coil 7 embedded (e.g. by epoxy potting or overmolding) in a fantail spacer 8 to read data from or write data to concentric data tracks on the magnetic disk 1. Generally, a voice coil motor (VCM) 10 is used to drive the voice coil 7.

Referring to FIGS. 2(a) and 3, a traditional head stack assembly (HSA) comprises an independent fantail spacer 8 which is interposed between two pieces of the drive arms 5 and combines with the drive arms 5 together with a securing means. The securing means is consisted of a pivot member 6, a washer 25′ and a nut 26′. In the prior art, the HGA 4 is coupled to the drive arm 5 by laser welding or swaging the suspension of the HGA 4 with the drive arm 5. The drive arms 5 each have a suspension flexure cable 20 running from the sliders 3 to a plurality of bonding pads 19.. The suspension flexure cable 20 is secured to the suspension of the HGA 4 by laser welding or adhesive.

In typical disk drives, referring to FIGS. 2(a) and 2(b), electrical control signals are communicated to the voice coil 7 by a flexible printed circuit assembly (FPCA) 9. The bonding pads 19 of the suspension flexure cable 20 are electrically connected with the FPCA 9 by using connection balls 15 (e.g., by soldering or ultrasonic bonding) to bond the bonding pads 19 to a plurality of connecting pads 16 of the FPCA 9. Thus, the FPCA 9 may communicate read/write data to the slider(s) 3. In addition, referring to FIG. 1, a printed circuit board (PCB) 11 mounted on a bracket 12 is provided to control the position of the drive arm(s) 5 with the slider(s) 3.

With reference to FIG. 2(a), the FPCA 9 is aligned with the fantail spacer 8 at an end thereof by an alignment pin 17 protruding from the fantail spacer 8. After positioning, the FPCA 9 will be electrically coupled to the HGA 4.

However, referring to FIG. 2(b), because the traditional manufacturing method of the HSA requires the connection balls 15 to be placed on the inside corner formed by the suspension flexure cables 20 and the FPCA 9, it causes a great trouble with the manufacturing process for the following reasons: firstly, the connection balls 15 are difficult to create and the above-mentioned corner is too limited a space to operate therein. In addition, the alignment of the connecting pads 16 of the FPCA 9 and the bonding pads 1 9 of the suspension flexure cables 20 and their electrical coupling is also a great challenge which will adversely affect the quality of the HSA and the efficiency of the manufacturing process, and increase the tooling and equipment costs as well.

Furthermore, the connection balls 15 must be cleaned immediately after they are soldered, that is, soldering flux, which is necessary for effectively soldering, must be removed, however, removing the soldering flux are difficult and costly. Also, the solder used for forming the connecting balls 15 can cause component contamination. More seriously, the solder may splash out and cause damage to the surrounding electrical components during soldering.

Lastly, because the HGA 4 and the suspension flexure cable 20 are coupled to the drive arm 5 by traditional methods, i.e. laser welding, swaging or adhesive, and the traditional methods is rather time-consuming and costly, so it will increase the manufacturing difficulty and the cost of the HSA.

It is therefore desirable to provide an improved manufacturing method of a HSA of a disk drive unit and to solve the above-mentioned problems.

### SUMMARY OF THE INVENTION

A main feature of the present invention is to provide a convenient and safe manufacturing method of a multi-head HSA of a disk drive unit.

Another feature of the present invention is to provide a low cost HSA of a disk drive unit which is easy to manufacture.

To achieve the above-mentioned feature, a method for manufacturing a head stack assembly of a disk drive unit comprises the steps of: forming a first head arm assembly having a first suspension flexure cable and a flexible printed circuit assembly; and bonding the first suspension flexure cable with the flexible printed circuit assembly by conductive epoxy to attain an electrical connection therebetween. As an embodiment of the present invention, the method further comprises the steps of: forming a second head arm assembly having a second suspension flexure cable; and assembling the first head arm assembly and the second head arm assembly; wherein assembling the first and second head arm assemblies comprises a step of bonding the first and second suspension flexure cables with the flexible printed circuit assembly by conductive epoxy to attain an electrical connection therebetween. In the present invention, the conductive epoxy is preferably Anisotropic Conductive Film (ACF).

In the present invention, forming the first head arm assembly further comprises forming a first suspension with a first slider, a first drive arm, a bracket, and a voice coil, and coupling the first suspension flexure cable with the first suspension; forming the second head arm assembly further comprises forming a second suspension and coupling the second suspension with the second suspension flexure cable. Hereinto, forming the first head arm assembly comprises a step of overmolding the first suspension, the bracket, and the voice coil onto the first drive arm. Forming the second head arm assembly comprises a step of overmolding the second suspension onto the second drive arm. In addition, the first and second suspension flexure cables are formed on the first and second suspension by overmolding, respectively.

In the present invention, forming the FPCA of the first head arm assembly comprises the steps of: forming a flexible printed circuit (FPC); forming a connector and forming a connection leg. In the present invention, forming the connector comprises forming two connection plates thereon and then forming a plurality of connecting pads on each of the two connection plates.

In a preferred embodiment of the present invention, forming a first head arm assembly further comprises forming a grounding pin and at least one connection pin thereon, and forming the connection leg further comprises forming a grounding pad and at least one voice coil pad corresponding to the grounding pin and the at least one connection pin. In addition, forming the first head arm assembly further comprises the step of electrically coupling the at least one connection pin and the grounding pin with the at least one voice coil pad and the grounding pad of the connection leg, respectively. Furthermore, forming the first and second suspension flexure cables comprises forming a plurality of bonding pads thereon, respectively; and the step of bonding the first and second suspension flexure cables with the FPCA is performed by bonding the bonding pads of the first and second suspension flexure cables with the connecting pads of the U-shaped connector together.

In the present invention, forming the first head arm assembly further comprise forming a bracket on one side thereof. Forming the bracket comprises forming a bracket body and a guiding rail. Forming the bracket body further comprises forming at least one bracket clamp on one side thereof and at least one alignment pin thereon. In the present invention, forming the flexible printed circuit (FPC) comprise forming at least one alignment hole thereon corresponding to the at least one alignment pin. Forming the first head arm assembly further comprises aligning the FPCA with the bracket by aligning at least one alignment hole of the flexible printed circuit with the alignment pin and fixing the flexible printed circuit by the bracket clamp.

A head stack assembly of a disk drive unit of the present invention comprises: a first head arm assembly having a first suspension flexure cable and a flexible printed circuit assembly; wherein a conductive epoxy is provided between the flexible printed circuit assembly and the first suspension flexure cable to attain an electrical connection therebetween. As an embodiment of the present invention, the head stack assembly further comprises a second head arm assembly having a second suspension flexure cable; wherein a conductive epoxy is provided between the flexible printed circuit assembly and the second suspension flexure cables to attain an electrical connection therebetween. In the present invention, the conductive epoxy is Anisotropic Conductive Film (ACF).

In the present invention, the first head arm assembly further comprises a first suspension with a first slider, a first drive arm, a bracket, and a voice coil, and the first suspension is coupled with the first suspension flexure cable; the second head arm assembly further comprises a second suspension which is coupled with the second suspension flexure cable. The first suspension, the bracket, and the voice coil are overmolded onto the first drive arm. In addition, the second suspension is overmolded onto the second drive arm. The first suspension flexure cable is overmolded onto the first suspension and the second suspension flexure cable is also overmolded onto the second suspension.

Comparing with the prior art, firstly, the present invention uses the conductive epoxy, such as anisotropic conductive film, to replace connection ball bonding, such as soldering or ultrasonic bonding to bond the suspension flexure cables with the FPCA for multi-head HSA termination so as to avoid creating and operating the connection balls in a small corner, and solve the clean and component contamination problem. Secondly, because the method of the present invention comprise the steps of forming the connector with two connection plates on the FPCA and then forming a plurality of connecting pads on each of the two connection plates, it makes the alignment of the connecting pads of the FPCA with the bonding pads of the suspension flexure cables easier, and to make their electrical coupling more reliable. In addition, forming the special bracket on the first HAA and the corresponding FPCA makes the electrical and physical connection therebetween more reliable. Lastly, because the method of the present invention utilizes the method of overmolding to bond the suspension with the drive arm, and to bond the suspension flexure cable assembly with the suspension, so it greatly simplifies the manufacturing process and reduces the manufacturing cost of the head stack assembly.

Other objects, advantages and novel features of the invention will become more apparent from the following detailed description of a preferred embodiment thereof when taken in conjunction with the accompanying drawings, wherein:

### DESCRIPTION OF THE DRAWINGS

FIG. 1 is a perspective view of a traditional disk drive;

FIG. 2(a) is a perspective view of a traditional head stack assembly (HSA);

FIG. 2(b) is an enlarged, cross-sectional view of an electrical connection between suspension flexure cables and a FPCA of the HSA of FIG. 2(a);

FIG. 3 is an exploded, perspective view of the HSA in FIG. 2(a);

FIG. 4 is a perspective view of a HSA according to the present invention;

FIG. 5 is an exploded, perspective view of the HSA of FIG. 4;

FIG. 6 is a perspective view of a first HAA of the HSA in FIG. 5;

FIG. 7(a) is an enlarged, perspective view of a FPCA of the HSA in FIG. 5;

FIG. 7(b) is an enlarged, perspective view of an assembly of the FPCA in FIG. 7(a) with a bracket in FIG. 6;

FIG. 8 is a perspective view of a second HAA of the HSA showing in FIG. 5;

FIG. 9 is a partial, enlarged perspective view of the first HAA in FIG. 6;

FIG. 10 is a partial, enlarged perspective view of the HSA in FIG. 4 showing an electrical connection between the suspension flexure cables and the FPCA; and

FIG. 11 is a schematic view showing a process of electrical connection between the suspension flexure cable and the FPCA of the HSA in FIG. 4.

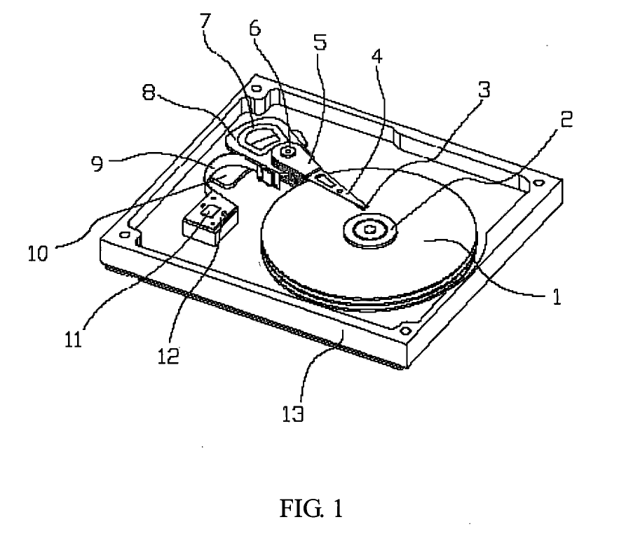

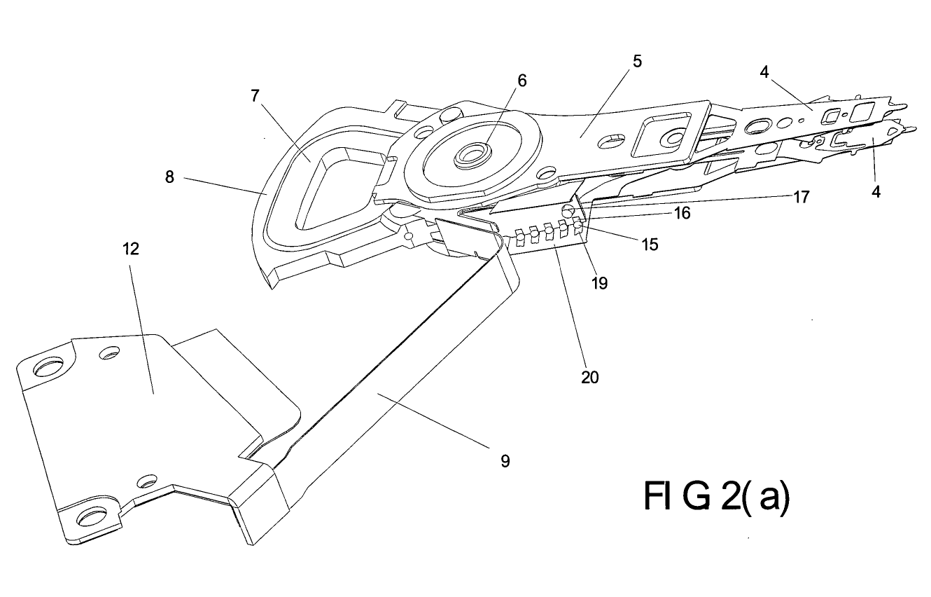

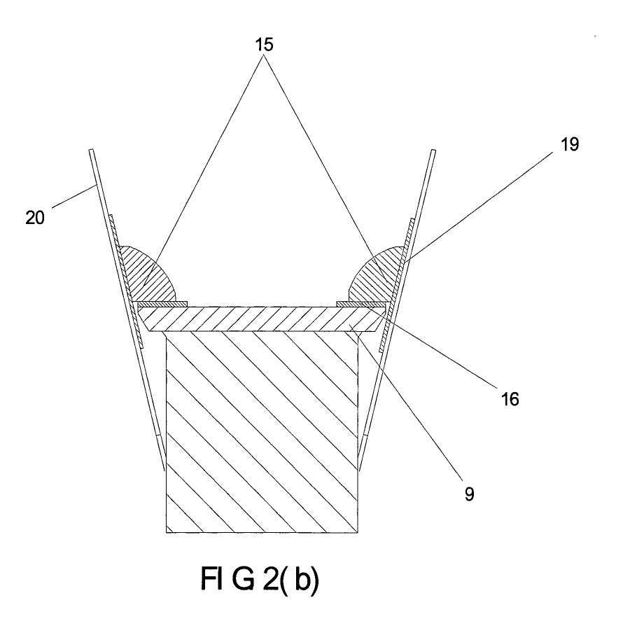

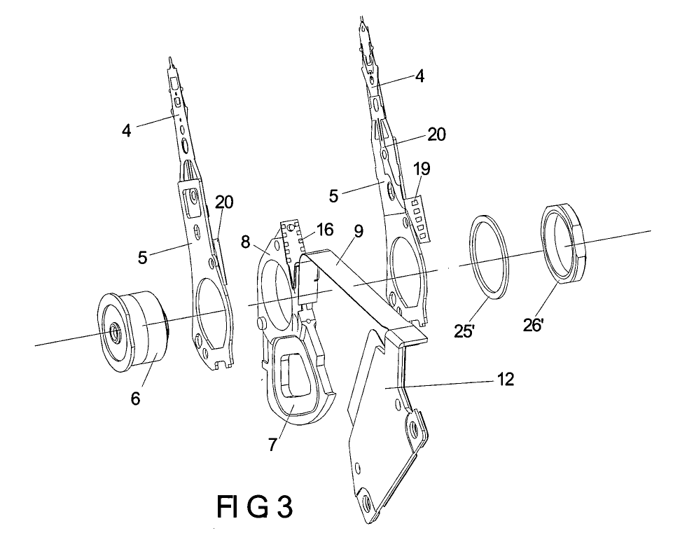

### DETAILED DESCRIPTION OF THE INVENTION

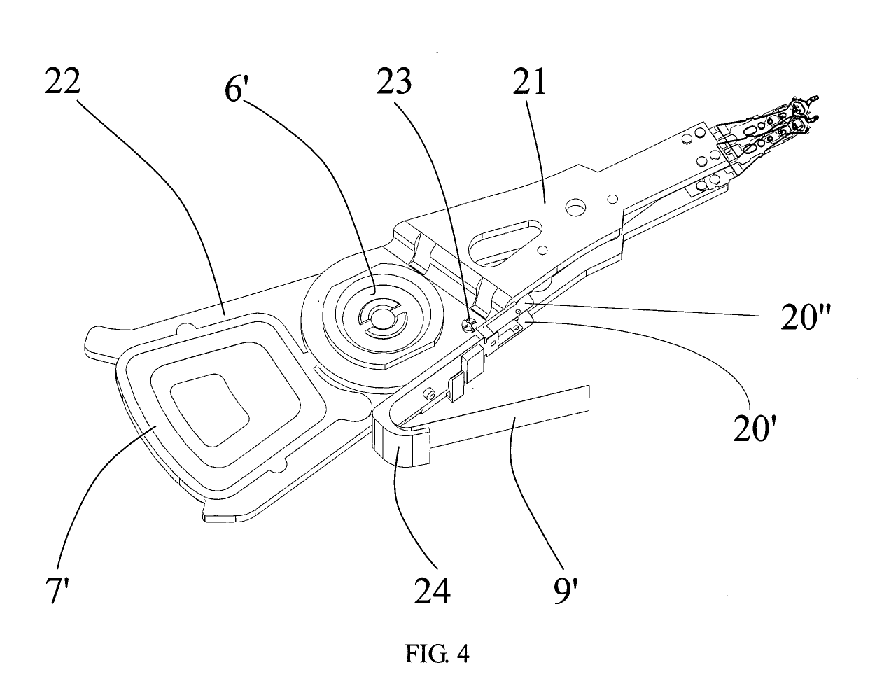

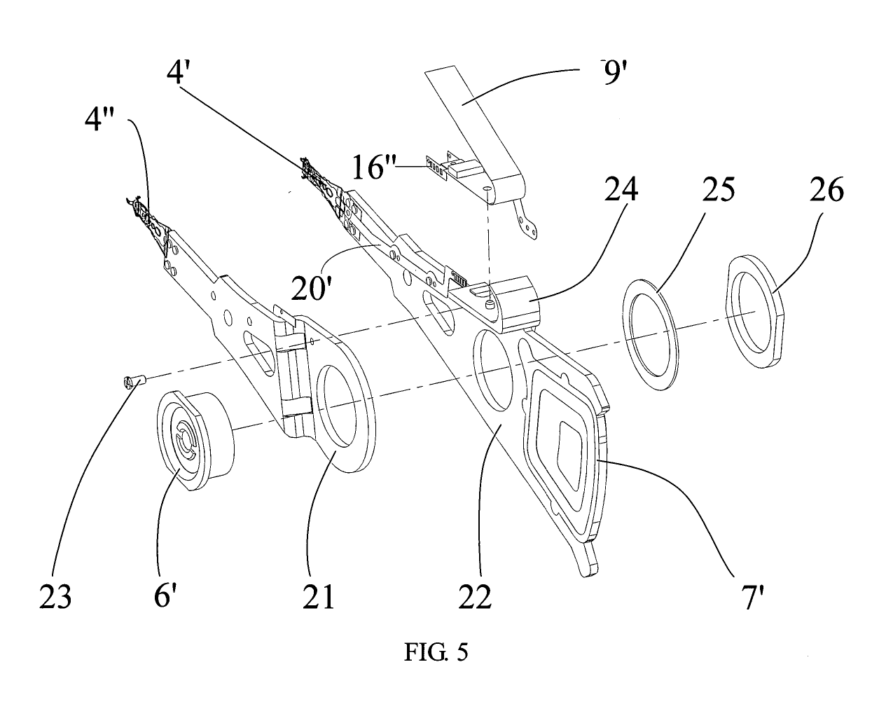

Referring now to the drawings in detail, FIG. 4 shows a HSA of a disk drive unit according to an embodiment of the present invention. The HSA comprises a first head arm assembly (HAA) 22 and a second HAA 21 coupled to the first HAA 22 by securing means (not labeled). In an embodiment of the present invention, see FIG. 5, the securing means comprises a pivot 6′, a washer 25, a nut 26 and a screw 23.

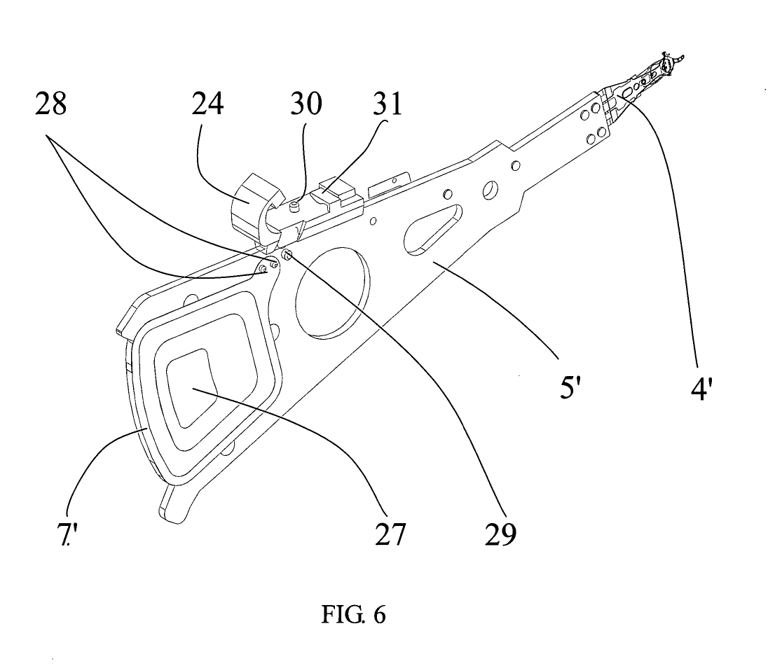

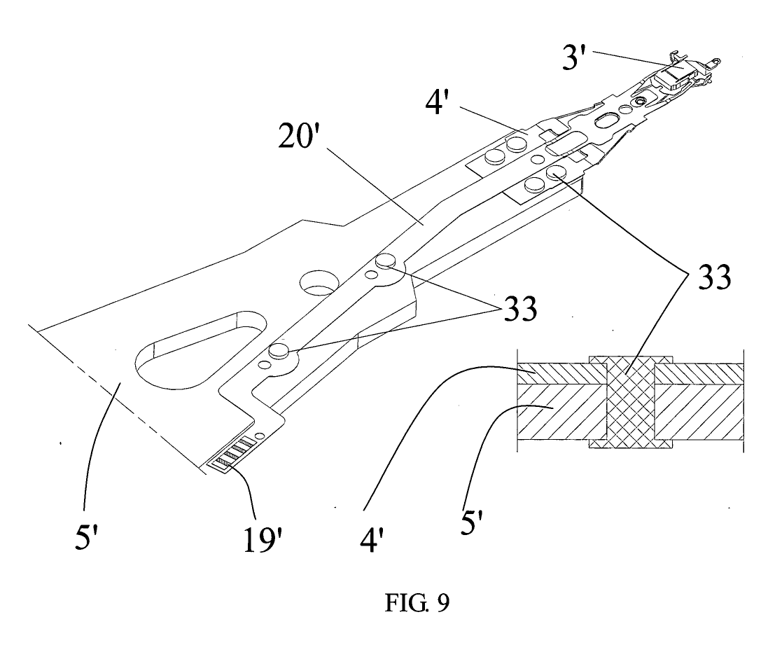

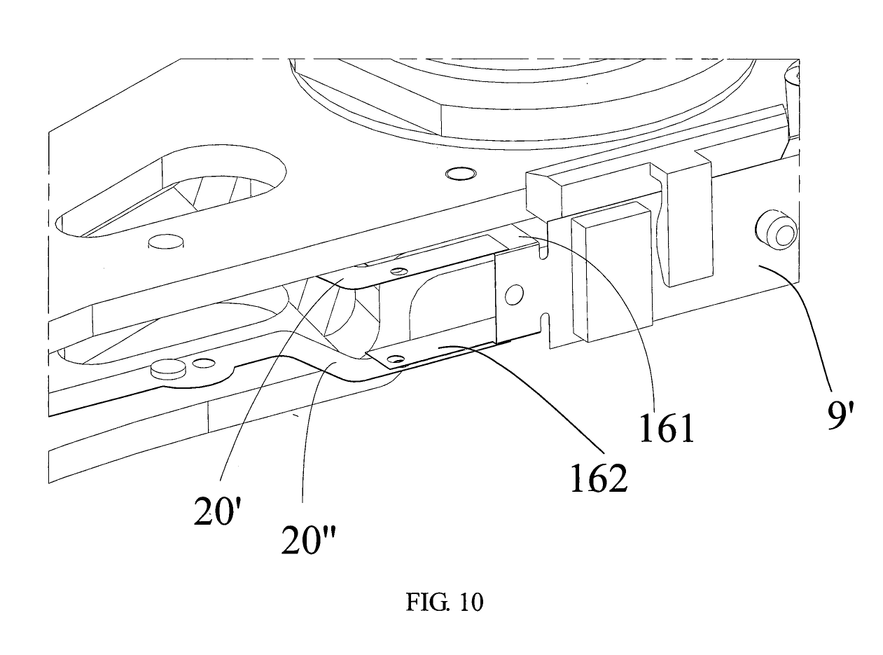

Referring to FIG. 6, the first HAA 22 comprises a first head gimbal assembly having a first suspension 4′ and a first slider 3′ (see FIG. 9), a first drive arm 5′ to be connected with to the first suspension 4′, a bracket 24 positioned on one side of the first drive arm 5′, and a voice coil 7′ embedded in the first drive arm 5′ for controlling the motion of the first drive arm 5′. In an embodiment of the invention, the bracket 24, the first suspension 4′, and the voice coil 7′ are overmolded onto the first drive arm 5′.

In the present invention, with reference to FIGS. 5, 6 and 9, the first suspension 4′ has a suspension flexure cable 20′ coupled thereon by overmolding which runs from the first slider 3′ toward the bracket 24. To make the invention easily understood, a detail view of overmold status of the first HAA 22 is shown in FIG. 9, there are at least two overmold pins 33 used for the attachment of the first suspension 4′, and at least two overmold pins 33 used for the attachment of the suspension flexure cable 20′. A plurality of bonding pads 19′ is provided on an end of the suspension flexure cable 20′. The drive arm 5′ is provided with a grounding pin 29 and two embedded connection pins 28 near the bracket 24. The voice coil 7′ is driven by a VCM (not shown), which is provided two voice coil leads (not shown) soldered with the connection pins 28. A balance plate 27 is mounted in the voice coil 7′ to balance the motion of the first drive arm 5′. The connection pins 28, the voice coil 7′ and the balance plate 27 are overmolded onto the first drive arm 5′ together.

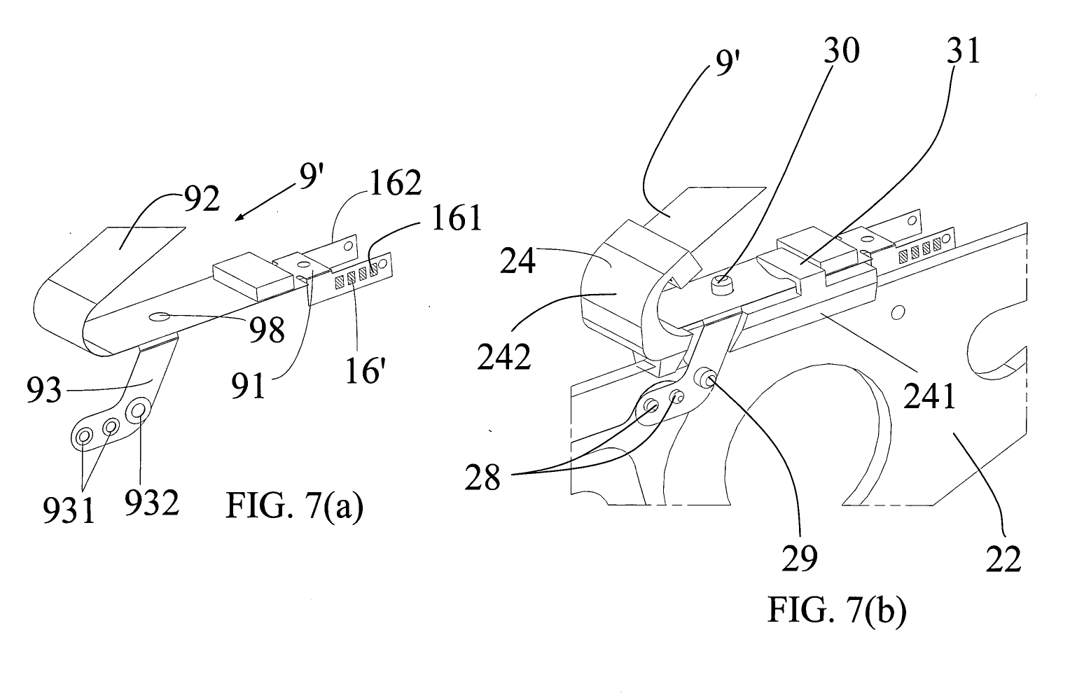

Referring to FIG. 7(b), the bracket 24 comprises a bracket body 241 and a guiding rail 242 extending from one end of the bracket body 241. The bracket body 241 has a bracket clamp 31 extending from one side thereof and an alignment pin 30 formed thereon. A FPCA 9′ is aligned with the bracket 24 by the alignment pin 30 and fixed by the bracket clamp 31. Referring to FIG. 7(a), the FPCA 9′ comprises a flexible printed circuit (FPC) 92, a U-shaped connector 91 formed to one end of the FPC 92, and a connection leg 93 extending from one side of the FPC 92. The FPC 92 has an alignment hole 98 formed therein corresponding to the alignment pin 30 to receive the alignment pin 30. The connection leg 93 has two voice coil pads 931 and a grounding pad 932 formed thereon, the two voice coil pads 931 are provided for the connection pins 28 to extend through, and the grounding pad 932 is provided for the grounding pin 29 to extend through. The U-shaped connector 91 comprises two connection plates 161, 162 with a plurality of connecting pads 16′ and 16″ (see FIG. 5) thereon, respectively. To satisfy the configuration of the guiding rail 242, the flexible printed circuit (FPC) 92 is folded to contact with the inner surface of the guiding rail 242.

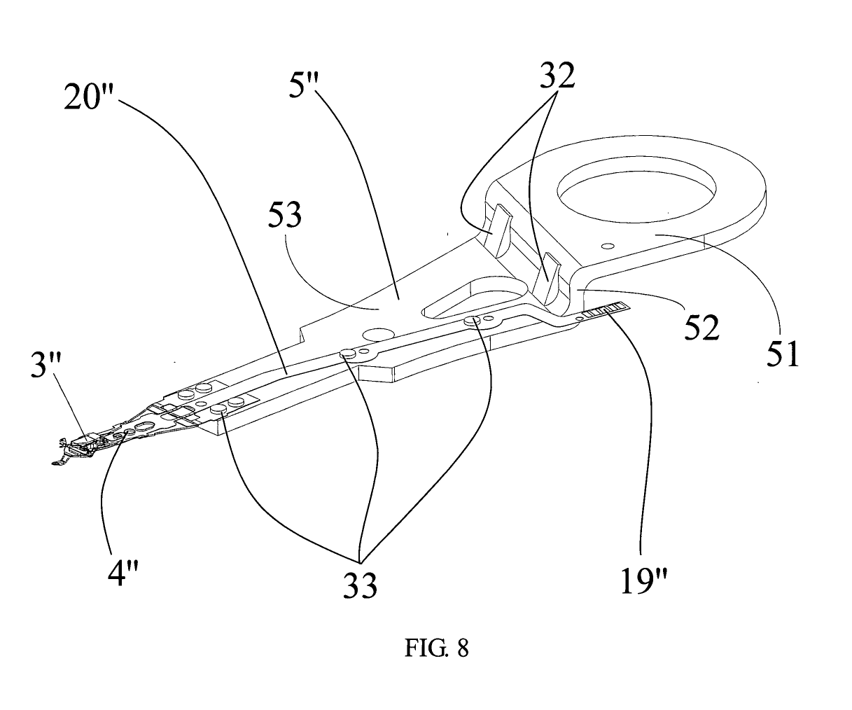

With reference to FIG. 8, the second HAA 21 comprises a second head gimbal assembly (HGA) having a second suspension 4″ and a second slider 3″, and a second drive arm 5″ to be connected with the second suspension 4″. The second suspension 4″ is provided a suspension flexure cable 20″ coupled thereon. In an embodiment of the present invention, the second suspension 4″ is overmolded onto the second drive arm 5″ and the suspension flexure cable 20″ are coupled with the second suspension 4″ by overmold as well. The second drive arm 5″ is stamped to form a step constructed by a securing portion 51, a connection portion 53 and a spacer 52 connecting the securing portion 51 with the connection portion 53. Two undercuts 32 are made on the spacer 52 to strengthen the second drive arm 5″. Additionally, the suspension flexure cable 20″ is also provided with a plurality of bonding pads 19″ on an end thereof. In the present invention, an overmold status of the second HAA 21 is similar to that of the first HAA 22 and a detail view thereof is omitted herefrom.

Referring to FIGS. 7(a) and 7(b), in the present invention, the voice coil pads 931 and the grounding pad 932 of the FPCA 9′ are electrically coupled with the connection pins 28 and the grounding pin 29 by soldering. At the same time, the voice coil leads (not shown) are electrically connected with the voice coil pads 931 because the voice coil leads (not shown) are soldered with the connection pins 28.

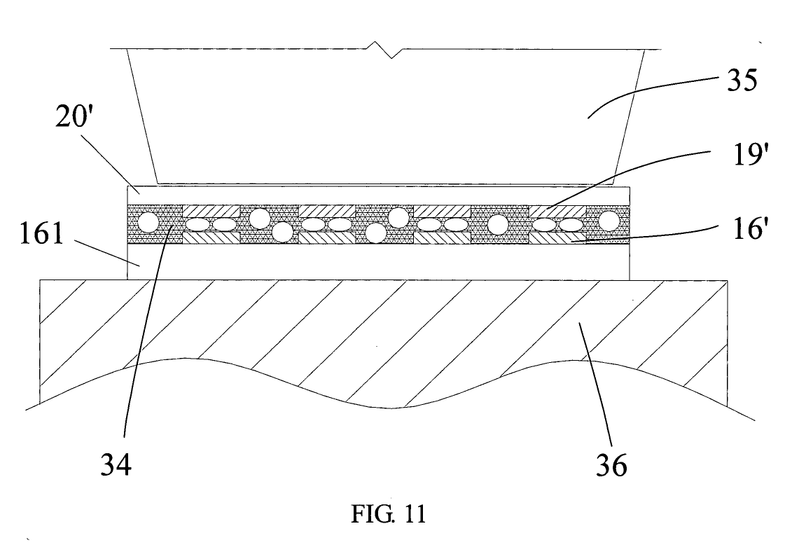

In the present invention, the bonding pads 19′, 19″ of the first and second suspension flexure cable 20′ and 20″ are electrically coupled with the connecting pads 16′, 16″ of the FPCA 9 by epoxy. Referring to FIG 11, in an embodiment, the epoxy is a tacky electrical conductive film 34, such as Anisotropic Conductive Film (ACF), which adheres to and covers the bonding pad 19′ of the first suspension flexure cable 20′. Then, the conductive film 34 is pressed against the connecting pad 16′ of the FPCA 9 by a bonding tip 35 to bond the bonding pad 19′ with the connecting pad 16′ together. The bonding tip 35 are heated and then compress the conductive film 34 to start the curing process. In an embodiment, an additional support plate 36 is inserted into the U-shaped connector 91 for support. Similarly, the bonding pads 19″ of the second suspension flexure cable 20″ are electrically coupled with the connecting pads 16″ of the FPCA 9 and a detailed description thereof is omitted herefrom.

Accordingly, a method for manufacturing a head stack assembly, comprising the steps of: (1) forming a first head arm assembly 22 having a first suspension flexure cable 20′ and a FPCA 9′; (2) forming a second head arm assembly 21 having a second suspension flexure cable 20″; (3) assembling the first head arm assembly 22 and the second head arm assembly 21; wherein assembling the first and second head arm assemblies 22, 21 comprises the step of bonding the first and second suspension flexure cables 20′, 20″ with the FPCA 9′ by conductive epoxy to attain an electrical connection therebetween. In the present invention, Anisotropic Conductive Film (ACF) is preferred as the conductive epoxy. In step (1), forming the FPCA 9′ of the first head arm assembly 22 comprises the steps of: forming a flexible printed circuit (FPC) 92; forming a U-shaped connector 91 and forming a connection leg 93. In the present invention, forming the U-shaped connector 91 comprises forming two connection plates 161, 162 thereon and then forming a plurality of connecting pads 16′, 16″ on the two connection plates 161, 162.

In a preferred embodiment of the present invention, forming the first head arm assembly 22 further comprises forming a grounding pin 29 and two connection pins 28 thereon, and forming the connection leg 93 further comprises forming a grounding pad 932 and two voice coil pads 931 corresponding to the grounding pin 29 and the two connection pins 28. In addition, forming the first head arm assembly 22 further comprises a step of electrically coupling the two connection pins 28 and the grounding pin 29 with the two voice coil pads 931 and the grounding pad 932 of the connection leg 93, respectively. Furthermore, forming the first and suspension flexure cables 20′, 20″ comprises forming a plurality of bonding pads 19′ and 19″ thereon, respectively; and the step of bonding the first and second suspension flexure cables 2 0′, 2 0″ with the FPCA 9′ is performed by bonding the bonding pads 19′ and 19″ of the first and second suspension flexure cables 20′, 20″ with the connecting pads 16′, 16″ of the U-shaped connector 91 together.

In the present invention, forming the first head arm assembly 22 further comprise forming a bracket 24 on one side thereof. Forming the bracket 24 comprises forming a bracket body 241 and a guiding rail 242. Forming the bracket body 241 further comprises forming a bracket clamp 31 on one side thereof and an alignment pin 30 thereon. In the present invention, forming the flexible printed circuit (FPC) 92 comprise forming an alignment hole 98 thereon corresponding to the alignment pin 30. Forming a first head arm assembly 22 further comprises aligning the FPCA 9′ with the bracket 24 by aligning the alignment hole 98 of the FPC 92 with the alignment pin 30 and fixing the FPC 92 by the bracket clamp 31.

It is understood that the invention may be embodied in other forms without departing from the spirit thereof. Thus, the present example and embodiment are to be considered in all respects as illustrative and not restrictive, and the invention is not to be limited to the details given herein.

1. A method for manufacturing a head stack assembly of a disk drive unit, comprising:
forming a first head arm assembly having a first suspension flexure cable and a flexible printed circuit assembly; and
bonding the first suspension flexure cable with the flexible printed circuit assembly by conductive epoxy to attain an electrical connection therebetween.

2. The method for manufacturing a head stack assembly as claimed in claim 1, wherein the method further comprises the steps of:
forming a second head arm assembly having a second suspension flexure cable; and
assembling the first head arm assembly and the second head arm assembly, wherein assembling the first and second head arm assemblies comprises bonding the first and second suspension flexure cables with the flexible printed circuit assembly by conductive epoxy to attain an electrical connection therebetween.

3. The method for manufacturing a head stack assembly as claimed in claim 2, wherein the conductive epoxy is anisotropic conductive film.

4. The method for manufacturing a head stack assembly as claimed in claim 2, wherein forming the first head arm assembly further comprises forming a first suspension with a first slider, a first drive arm, a bracket, and a voice coil, and coupling the first suspension flexure cable with the first suspension; and forming the second head arm assembly further comprises forming a second suspension and coupling the second suspension with the second suspension flexure cable.

5. The method for manufacturing a head stack assembly as claimed in claim 4, wherein forming the first head arm assembly comprises overmolding the first suspension, the bracket, and the voice coil onto the first drive arm.

6. The method for manufacturing a head stack assembly as claimed in claim 4, wherein forming the second head arm assembly comprises overmolding the second suspension onto the second drive arm.

7. The method for manufacturing a head stack assembly as claimed in claim 4, wherein the first suspension flexure cable is formed on the first suspension by overmolding and the second suspension flexure cable is also formed on the second suspension by overmolding.

8. The method for manufacturing a head stack assembly as claimed in claim 1, wherein forming the flexible printed circuit assembly of the first head arm assembly comprises forming a flexible printed circuit (FPC); and forming a connector and forming a connection leg.

9. The method for manufacturing a head stack assembly as claimed in claim 8, wherein forming the connector comprises forming two connection plates thereon, and forming a plurality of connecting pads on each of the two connection plates.

10. The method for manufacturing a head stack assembly as claimed in claim 8, wherein forming a first head arm assembly further comprises forming a grounding pin and at least one connection pin thereon, and forming the connection leg further comprises forming a grounding pad and at least one voice coil pad corresponding to the grounding pin and the at least one connection pin.

11. The method for manufacturing a head stack assembly as claimed in claim 10, wherein forming the first head arm assembly further comprises a step of electrically coupling the at least one connection pin and the grounding pin with the at least one voice coil pad and the grounding pad of the connection leg, respectively.

12. The method for manufacturing a head stack assembly as claimed in claim 9, wherein forming the first and suspension flexure cables comprises forming a plurality of bonding pads thereon, respectively; and wherein bonding the first and second suspension flexure cables with the flexible printed circuit assembly is performed by bonding the bonding pads of the first and second suspension flexure cables with the connecting pads of the connector together.

13. The method for manufacturing a head stack assembly as claimed in claim 1, wherein forming the first head arm assembly further comprises forming a bracket on one side thereof.

14. The method for manufacturing a head stack assembly as claimed in claim 13, wherein forming the bracket comprises forming a bracket body and a guiding rail.

15. The method for manufacturing a head stack assembly as claimed in claim 14, wherein forming the bracket body further comprises forming at least one bracket clamp on one side thereof and at least one alignment pin thereon.

16. The method for manufacturing a head stack assembly as claimed in claim 15, wherein forming the flexible printed circuit (FPC) comprises forming at least one alignment hole thereon corresponding to the at least one alignment pin.

17. The method for manufacturing a head stack assembly as claimed in claim 16, wherein forming a first head arm assembly further comprises aligning the flexible printed circuit assembly with the bracket by aligning at least one alignment hole of the flexible printed circuit with the alignment pin and fixing the flexible printed circuit by the bracket clamp.

18. A head stack assembly of a disk drive unit comprises:
a first head arm assembly having a first suspension flexure cable and a flexible printed circuit assembly, wherein a conductive epoxy is provided between the flexible printed circuit assembly and the first suspension flexure cable to attain an electrical connection therebetween.

19. The head stack assembly according to claim 18, wherein the head stack assembly further comprises a second head arm assembly having a second suspension flexure cable, wherein a conductive epoxy is provided between the flexible printed circuit assembly and the second suspension flexure cables to attain an electrical connection therebetween.

20. The head stack assembly according to claim 19, wherein the conductive epoxy is anisotropic conductive film.

21. The head stack assembly according to claim 19, wherein the first head arm assembly further comprises a first suspension with a first slider, a first drive arm, a bracket, and a voice coil, and the first suspension is coupled with the first suspension flexure cable; the second head arm assembly further comprises a second suspension which is coupled with the second suspension flexure cable.

22. The head stack assembly according to claim 21, wherein the first suspension, the bracket, and the voice coil are overmolded onto the first drive arm.

23. The head stack assembly according to claim 21, wherein the second suspension is overmolded onto the second drive arm.

24. The head stack assembly according to claim 21, wherein the first suspension flexure cable is overmolded onto the first drive arm and the second suspension flexure cable is also overmolded onto the second drive arm.

25. The head stack assembly according to claim 18, wherein the flexible printed circuit assembly comprises a flexible printed circuit (FPC), a connector and a connection leg.

26. The head stack assembly according to claim 25, wherein the connector comprises two connection plates and a plurality of connecting pads formed on each of the two connection plates.

27. The head stack assembly according to claim 25, wherein the first head arm assembly further comprises a grounding pin and at least one connection pin, and the connection leg further comprises a grounding pad and at least one voice coil pad corresponding to the grounding pin and the at least one connection pin.

28. The head stack assembly according to claim 27, wherein the at least one connection pin and the grounding pin are electrically coupled with the at least one voice coil pad and the grounding pad of the connection leg, respectively.

29. The head stack assembly according to claim 26, wherein each of the first and second suspension flexure cables comprises a plurality of bonding pads thereon; and the bonding pads of the first and second suspension flexure cables are bonded with the connecting pads of the connector together.

30. The head stack assembly according to claim 18, wherein the first head arm assembly further comprises a bracket on one side thereof.

31. The head stack assembly according to claim 30, wherein the bracket comprises a bracket body and a guiding rail.

32. The head stack assembly according to claim 31, wherein the bracket body further comprises at least one bracket clamp on one side thereof and at least one alignment pin thereon.

33. The head stack assembly according to claim 25, wherein the flexible printed circuit (FPC) comprises at least one alignment hole thereon corresponding to the at least one alignment pin.

34. The head stack assembly according to claim 33, wherein the at least one alignment hole of the flexible printed circuit is aligned with the alignment pin so as to align the flexible printed circuit assembly with the bracket, and the flexible printed circuit is fixed by the bracket clamp.
